(19) United States
(12) Patent Application Publication
(10) Pub. No.: US 2008/0038566 A1
(43) Pub. Date: Feb. 14, 2008

(54) Electrically biasable electrographic member

(75) Inventors: Craig M. Cody, Scottsville, NY (US); Andrew P. Kittleson, Rochester, NY (US); Thomas N. Tombs, Rochester, NY (US); Mark C. Zaretsky, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/503,596

(22) Filed: Aug. 14, 2006

(51) Int. Cl. B32B 15/04

(52) U.S. Cl. 428/457

(57) ABSTRACT

The present invention is an intermediate transfer member for use in an electrostatographic machine. The intermediate transfer member includes an insulating support layer having an inner side and outer side, with a conductive layer disposed on at least the outer side. There is at least one conductive connection between the inner side of the insulating support layer and the conductive outer layer.

### CROSS-REFERENCE TO RELATED APPLICATIONS

This application relates to commonly assigned applications Ser. No. ______ (Docket 91084), Ser. No. ______ (Docket 92462) and Ser. No. ______ (Docket 92915) filed simultaneously herewith and herby incorporated by reference for all that it discloses.

### FIELD OF THE INVENTION

The present invention relates to electrostatography, including electrography and electrophotography, and more particularly, to the design of a low cost intermediate transfer member.

### BACKGROUND OF THE INVENTION

As described in U.S. Pat. Nos. 5,084,735 and 5,370,961, there are several benefits to performing an intermediate, rather than direct, electrostatic transfer process, for single color and more particularly, for the case of multicolor imaging. One benefit is the ease of registration, where the intermediate transfer member may be used to receive a number of single-color images in register to form a multicolor image, thereby removing the variability of the final image receiver from the registration process. Another benefit is improved image quality, particularly if a compliant intermediate transfer member is used. A compliant intermediate transfer member can enhance the transfer efficiency to rough receivers as the compliancy allows the intermediate transfer member to conform to the surface roughness of the receiver. The compliance of the intermediate transfer member can also provide benefits with respect to the defect of hollow character, where the interior of small size characters and small width lines can sometimes fail to transfer in a non-compliant system, either for intermediate or direct transfer.

Compliant intermediate transfer members may be constructed in the form of sleeved rollers, as described by Cormier et al, in U.S. Pat. No. 6,394,943, where images are formed on or transferred to a drum having a flexible or resilient outer sleeve that, from time to time, requires replacement. Typically, the sleeve is operatively supported by a metal cylinder or mandrel. In loading the sleeve onto the mandrel, it is common to inject air into the sleeve, thereby slightly expanding the sleeve diameter, while sliding the sleeve axially onto the mandrel's supporting surface. Usually, the nominal diameter of the resilient sleeve is slightly less than the mandrel diameter. Thus, upon discontinuing the airflow, the sleeve contracts onto the mandrel and forms a tight, interference fit.

There are significant costs associated with compliant sleeve design. In order to meet registration requirements high precision grinding operations are necessary to establish low run-out and surface roughness properties. The support for the sleeve member is typically a seamless metal, which adds significant cost to manufacture the sleeve. Additionally, in order to meet transfer and registration requirements, the sleeve must have a uniform diameter within narrow tolerances in order to minimize variations in overdrive and nip width. The grinding operation typically used to obtain the correct diameter is a manufacturing step adding significant cost to manufacture the sleeve.

Chowdry et al, U.S. Pat. No. 6,377,772, provide an improved solution to the multi-layer roller by describing a double-sleeved roller including a rigid cylindrical core member, a replaceable removable compliant inner sleeve member in non-adhesive contact with and surrounding the core member, and a replaceable removable outer sleeve member in non-adhesive contact with and surrounding the inner sleeve member. Although the invention enables the independent replacement of the inner and outer sleeves to reduce the costs of the components, the means envisioned for installing the members increases the complexity and cost of the mandrel support apparatus and limits the range of materials that can be used to obtain a working double-sleeved roller.

Described in an accompanying disclosure, Docket 92462, and incorporated by reference herein, is a simplified mounting method for a double-sleeved roller member (DSR) by enabling a method of mounting both components of a DSR configuration simultaneously. This method also reduces the cost of a DSR by relaxing tolerances and broadening suitable material choices for the stiffening layer. An improved double-sleeved roller mounting method enables a compliant inner sleeve member (ISM) and a compliant outer sleeve member (OSM) with improved structure that lowers manufacturing costs. This method lso reduces the cost of the electrostatographic apparatus for mounting a DSR as a simultaneous mounting of the ISM and OSM allows the hardware of the mandrel to be as simple as a single sleeve roller installation.

Described in an accompanying disclosure, Docket 91084, and incorporated here by reference, is a manufacturing method for producing a thinner OSM by casting a compliant layer over a seamed low-cost substrate, preferably plastic, having very good thickness uniformity without the need for a surface grind, thereby enabling a low cost manufacturing process.

Intermediate transfer members may also be constructed in the form of endless webs or belts. These belts may have a single or multi-layered structure. A substrate or base layer for the belts may be formed by manufacturing processes such as centrifugal casting, U.S. Pat. No. 6,281,324, or extrusion through a circular die, U.S. Pat. No. 6,303,072, resulting in a seamless belt. Or, a seamed belt may be formed by extruding a roll of plastic film, cutting an appropriate length and/or width of film and joining the ends together using a variety of techniques such as adhesive bonding or ultrasonic welding. A compliant layer may then be coated onto the substrate using an injection molding process or a casting process as described in accompanying disclosure, Docket 91084.

It is highly desirable to use a bulk static dissipative plastic film to serve as a substrate providing rigidity and mechanical integrity for an intermediate transfer member, be it roller or belt. Furthermore, for the case of a double-sleeved intermediate transfer roller, it is highly desirable to use a bulk static dissipative plastic film to serve as the substrate for the OSM. Conduction of electrical charges through the bulk of the plastic film facilitates the electrical biasing of the intermediate transfer member for electrostatic transfer of toner onto and off of its surface. Examples of materials used as such plastic films include polyimide, polyester, polycarbonate, a fluorinated polymer, or acetal. Examples of materials used as conductive addenda in the manufacture of these bulk static dissipative plastic films include electronic conductive addenda such as carbon black, carbon nanotubes, metals, and metal oxides, or ionic conductive addenda such as quaternary ammonium salts, or various combinations of electronic and/or ionic conductive addenda.

However, whereas insulating plastic films having a surface conductive layer are readily manufacturable at low cost and are widely used throughout many industries and applications, it is costly to manufacture bulk static dissipative plastic films having a more specialized application and limited applicability. As described in U.S. Pat. Nos. 6,397,034, 6,228,448, 5,409,557, and 5,899,610, a variety of manufacturing approaches have been developed to produce bulk static dissipative plastic films, all suffering from issues such as manufacturing process complexity, slow speed, and high capital cost.

For intermediate transfer belts, the most common commercially available construction at present is a carbon filled polyimide belt. The volume resistivity of this belt relies upon carbon-to-carbon contact and is, therefore, highly sensitive to carbon concentration and dispersion, particularly in the static dissipative range of 10⁷ to 10¹² ohm-cm, as required for intermediate transfer belt applications. As it is difficult to control critical factors such as the quality of the carbon dispersion, the volume resistivity of these belts can be quite variable, both within a belt and from belt-to-belt, with variability on the order of +/−1 order of magnitude. The nature of the particle-to-particle conduction process in this static dissipative range results in a highly non-ohmic behavior, complicating the electrical response of this belt when electrically biased and passed through a transfer nip. Furthermore, the manufacturing process can result in an anisotropic behavior of the volume resistivity, often resulting in a situation where current flow in the plane of the film is significantly higher than current flow through the thickness of the film, by roughly 1 to 3 orders of magnitude. This further limits the usable range of films as belts that might have an acceptable volume resistivity, as measured through the belt thickness, may have an unacceptably low surface resistivity, as measured in the plane of the film.

Owing to these difficulties in fabrication of an inexpensive intermediate transfer substrate having a bulk static dissipative nature and good electrical uniformity, both within a substrate and from substrate-to-substrate, for application either as a belt or as a sleeve for a roller, an alternative approach has been described using an inexpensive, readily available single-sided or double sided conductively coated plastic film to form a rigid substrate in a compliant, multi-layered intermediate transfer member structure.

U.S. Pat. No. 6,377,772 describes an embodiment where an outer sleeve stiffening layer of a double sleeved electrostatographic roller is non-conductive and has a metallic film applied to the stiffening layer, which is connected to an electrical source of voltage or current. US Patent Publication 2004/0086305 describes an intermediate transfer member having three layers: a non-conductive layer such as film (e.g., electrically insulating or insulative film, by way of non-limiting example, especially polymeric insulative film), a conductive layer on top of the non-conductive layer, and an electrically resistive polymeric layer on top of the conductive layer. After the resistive layer has been coated, the multi-layer structured film is cut into sheets of the proper size, the ends of these sheets lapped and ultrasonically welded to form a durable endless belt. US Patent Publication 2005/0249530 similarly describes a reinforcing layer for an outer body portion that may be selected from a plastic film, having a conductive layer over the reinforcing layer, and a conforming layer over the conductive layer, with a release layer overlying the conductive layer.

For all these approaches utilizing an intermediate transfer member comprising an inexpensive insulating plastic film having a surface conductive layer, there is a need to establish an electrostatic transfer field while circumventing the high impedance provided by the insulating plastic film so as to operate at lower bias voltages and reduce the occurrence of air discharges, particularly when transferring toner onto the intermediate member. This leads to the difficulty of providing an electrical connection between a high voltage power supply and a non-stationary surface conductive layer. There is the necessity to provide additional parts to make the contact, such as a conductive brush or spring steel along with appropriate mounting hardware, and a more complex manufacturing process whereby a portion of the conductive layer remains accessible for electrical contact even though most of conductive layer will be buried under at least one additional layer that may be compliant and static dissipative in nature.

In view of the foregoing discussion, an object of this invention is to provide a low cost intermediate transfer member utilizing a bulk insulating plastic film having at least one surface conductive layer where electrical continuity is integral to the member, eliminating the need for an external electrical contact to the at least one surface conductive layer.

Another object of the invention is to provide a low cost intermediate transfer member utilizing a bulk insulating plastic film having at least one surface conductive layer whereby the bulk insulating plastic film is rendered electrically invisible.

Another object of the invention is to provide a low cost intermediate transfer member utilizing a bulk insulating plastic film having at least one surface conductive layer and a seam rendered invisible by a compliant layer coated onto the surface conductive layer.

Another object of the invention is to provide a low cost intermediate transfer member utilizing a bulk insulating plastic film having at least one surface conductive layer to be fabricated as the stiffening layer of an outer sleeve member of a double sleeved intermediate transfer roller.

Another object of the invention is to provide a low cost intermediate transfer member utilizing a bulk insulating plastic film having at least one surface conductive layer to be fabricated as the substrate layer of an intermediate transfer web or belt.

### SUMMARY OF THE INVENTION

The present invention is an intermediate transfer member for use in an electrostatographic machine. The intermediate transfer member includes an insulating support layer having an inner side and outer side, with a conductive layer disposed on at least the outer side. There is at least one conductive connection between the inner side of the insulating support layer and the conductive outer layer.

### BRIEF DESCRIPTION OF THE DRAWINGS

FIG. 1(a) is a perspective view of double-coated film with at least one hole filled with a conductor. FIG. 1b) shows a cross-sectional view of a double-coated film with at least one hole filled with conductor and overcoated with compliant and release layers.

FIG. 2(a) is a perspective view of double-coated film with seam and a conductive adhesive filled joint. FIG. 2 (b) shows a cross-sectional view of a double-coated film with seam and a conductive adhesive filled joint and overcoated with compliant and release layers.

FIG. 3(a) is a perspective view of double-coated film with seam and tape with conductive adhesive folded over the edge of the film. FIG. (3b) shows a cross-sectional view of a double-coated film with seam and tape with conductive adhesive folded over the edge of the film and overcoated with compliant and release layers.

FIG. 4(a) is a perspective view of double-coated film with seam and tape with conductive adhesive folded over the edge of the film. FIG. (4b) shows a cross-sectional view of a double-coated film with seam and tape with conductive adhesive folded over the edge of the film and overcoated with compliant and release layers.

FIG. 5(a) is a perspective view of double-coated film with perforations. FIG. 5(b) shows a cross-sectional view of a double-coated film with perforations, overcoated with an elastomer that fills the perforations and further overcoated with a release layer.

FIG. 6(a) is a cross-sectional view, not to scale, of a double-sleeved intermediate transfer member (DSITM) roller according to an embodiment of the invention. FIG. 6(b) is a cross-sectional view, not to scale, of a DSITM roller according to an embodiment of the invention.

FIG. 7 is a schematic perspective view, not to scale, of a DSITM outer sleeve support layer (OSSL) according to an embodiment of the invention.

For better understanding of the present invention, together with other advantages and capabilities thereof, reference is made to the following detailed description in connection with the above-described drawings.

### DETAILED DESCRIPTION OF THE INVENTION

In the detailed description of the preferred embodiments of the invention presented below, reference is made to the accompanying drawings, in some of which the relative relationships of the various components are illustrated, it being understood that orientation of the apparatus may be modified. For clarity of understanding of the drawings, relative proportions depicted or indicated of the various elements of which disclosed members are included may not be representative of the actual proportions, and some of the dimensions may be selectively exaggerated.

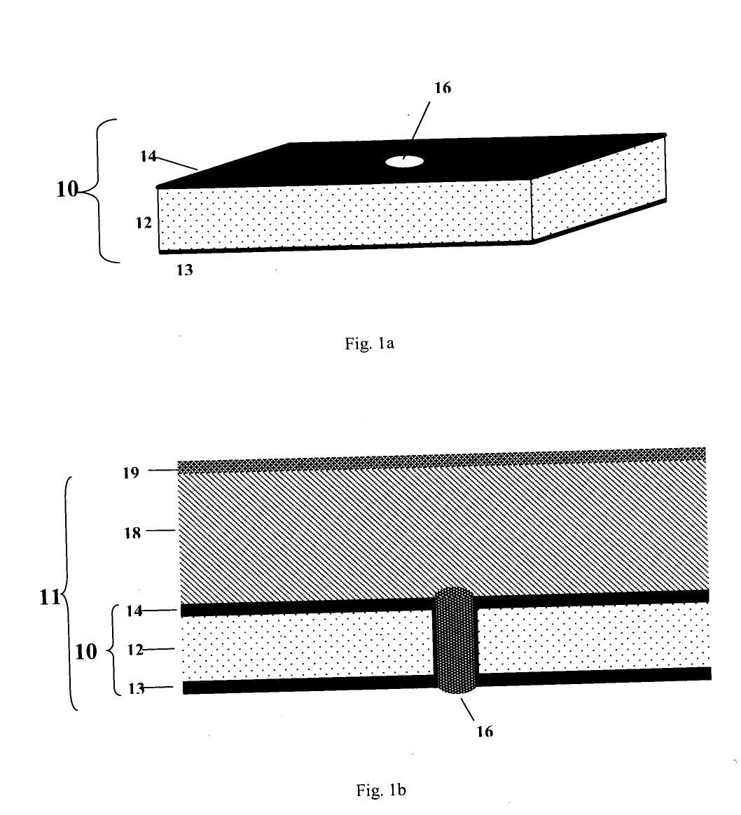

A preferred embodiment of the invention may be found in FIGS. 1 (a) and 1 (b). Shown in FIG. 1 (a) is intermediate transfer substrate 10 including an insulating plastic film 12 having surface conductive layers 13 and 14 deposited on either side of film 12. A hole or perforation has been made in intermediate transfer substrate 10 and filled with conductive material 16. Conductive material 16 provides a low resistance electrical path between conductive layers 13 and 14. Subsequently, the ends of film 12 are joined so as to form an endless belt or sleeve. Shown in FIG. 1 (b) is intermediate transfer member 11, including intermediate transfer substrate 10 with compliant layer 18 coated on top of conductive layer 14. Preferably, a release layer 19 is coated on top of compliant layer 18.

Suitable materials for use as an insulating plastic film 12 include, but are not limited to, polyesters, polyurethanes, polyimides, polyvinyl chlorides, polyolefins (such as polyethylene and polypropylene) and/or polyamides (such as nylon), polycarbonates, or acrylics, or blends, or copolymers, or alloys of such materials, or fluorinated polymers, or any other substrate material that would meet the requirements of flexibility, strength, and durability, to maintain integrity under the conditions of use (e.g. pressure and tension).

Suitable materials for use as surface conductive layers 13 and 14 include, but are not limited to, vapor deposited aluminum, nickel, or indium tin oxide, or solution coated polythiophene, tin oxide, carbon black, carbon nanotubes, or polyaniline.

Suitable materials for use as a conductive material 16 include, but are not limited to, solder or a paint, epoxy, or paste that is filled with a conductive material such as silver, carbon black, carbon fibers or carbon nanotubes.

Suitable means for joining the ends of intermediate transfer substrate 10 include, but are not limited to, adhesive bonding, adhesive tape, welding, mechanical interlocking, sewing, wiring, or stapling.

Suitable materials for a compliant layer 18 include, but are not limited to, polyurethanes, neoprenes, silicones, fluoropolymers, silicone-fluoropolymer hybrids, nitrites, or silicon-nitriles.

Suitable materials for a release layer 19 include, but are not limited to, a sol-gel, a ceramer, a polyurethane or a fluoropolymer, but other materials having good release properties including low surface energy materials may also be used.

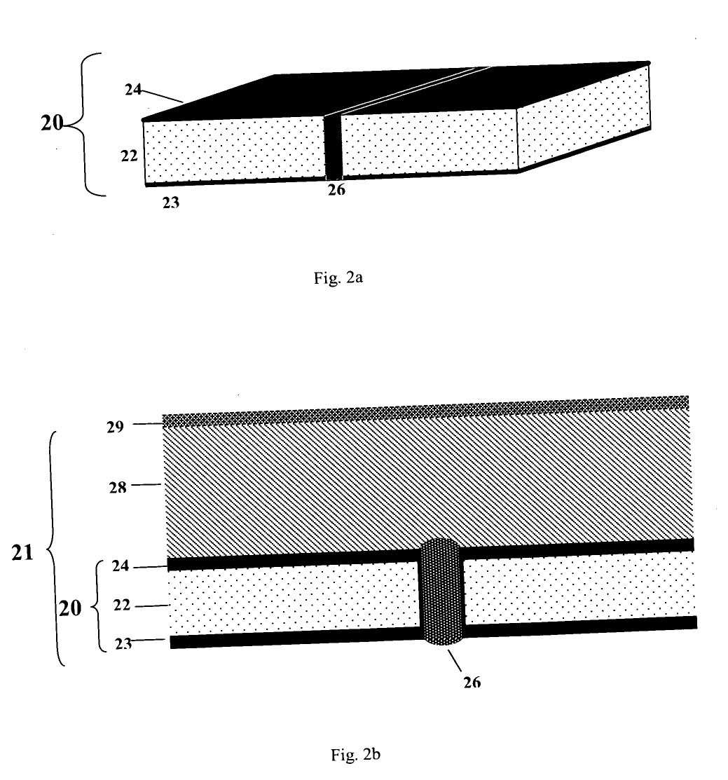

A second embodiment of the invention may be found in FIGS. 2 (a) and 2 (b). Shown in FIG. 2 (a) is intermediate transfer substrate 20 including an insulating plastic film 22 having surface conductive layers 23 and 24 deposited on either side of film 22. The ends of intermediate transfer substrate 20 are then joined together using a conductive adhesive 26 to form an endless belt or sleeve. Conductive adhesive 26 provides a low resistance electrical path between conductive layers 23 and 24. Shown in FIG. 2 (b) is intermediate transfer member 21, including intermediate transfer substrate 20 with compliant layer 28 coated on top of conductive layer 24. Preferably, a release layer 29 is coated on top of compliant layer 28. The materials for use as intermediate transfer member 21, compliant layer 28, and release layer 29 in this embodiment are the same as those listed for the first embodiment shown in FIGS. 1 (a) and 1 (b).

Suitable materials for conductive adhesive 26 include, but are not limited to, hot melt adhesives such as polyamides, urethanes, or polyesters, or UV-curable adhesives such as acrylic epoxies, polyvinyl butyrals, or the like, where electrical conductivity is provided by incorporating into the adhesive a conductive component such as silver, indium tin oxide, cuprous iodide, tin oxide, 7,7′,8,8′-tetracyanoquinonedimethane (TCNQ), quinoline, carbon black, NiO and/or ionic complexes such as quaternary ammonium salts, metal oxides, graphite, or like conductive fillers in particulate, flake or fiber form and conductive polymers such as polyaniline and polythiophenes.

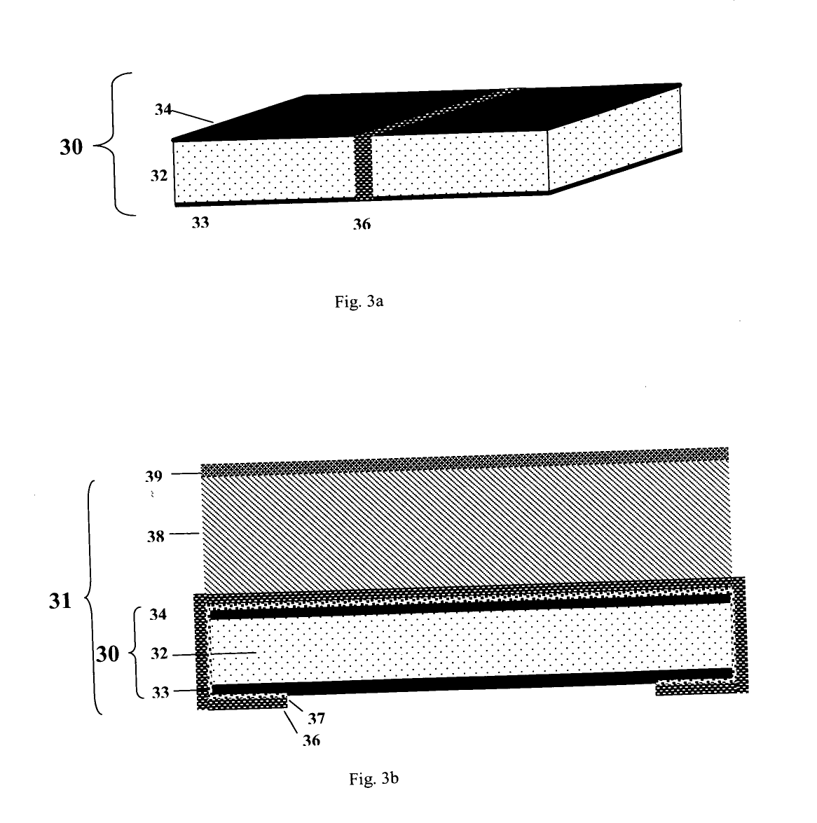

A third embodiment of the invention may be found in FIGS. 3 (a) and 3 (b). Shown in FIG. 3 (a) is intermediate transfer substrate 30 including an insulating plastic film 32 having surface conductive layers 33 and 34 deposited on either side of film 32. The ends of intermediate transfer substrate 30 are then joined together to form an endless belt or sleeve using a tape 36 having a conductive adhesive 37 and folded over at least one edge of intermediate transfer substrate 30. Conductive adhesive 37 provides a low resistance electrical path between conductive layers 33 and 34. In addition, tape 36 may also be conductive so as to minimize the loss of electric field in a transfer nip. Shown in FIG. 3 (b) is intermediate transfer member 31, including intermediate transfer substrate 30 with compliant layer 38 coated on top of conductive layer 34. Preferably, a release layer 39 is coated on top of compliant layer 38. The materials for use as intermediate transfer member 30, compliant layer 38, and release layer 39 in this embodiment are the same as those listed for the first embodiment shown in FIGS. 1(a) and 1(b).

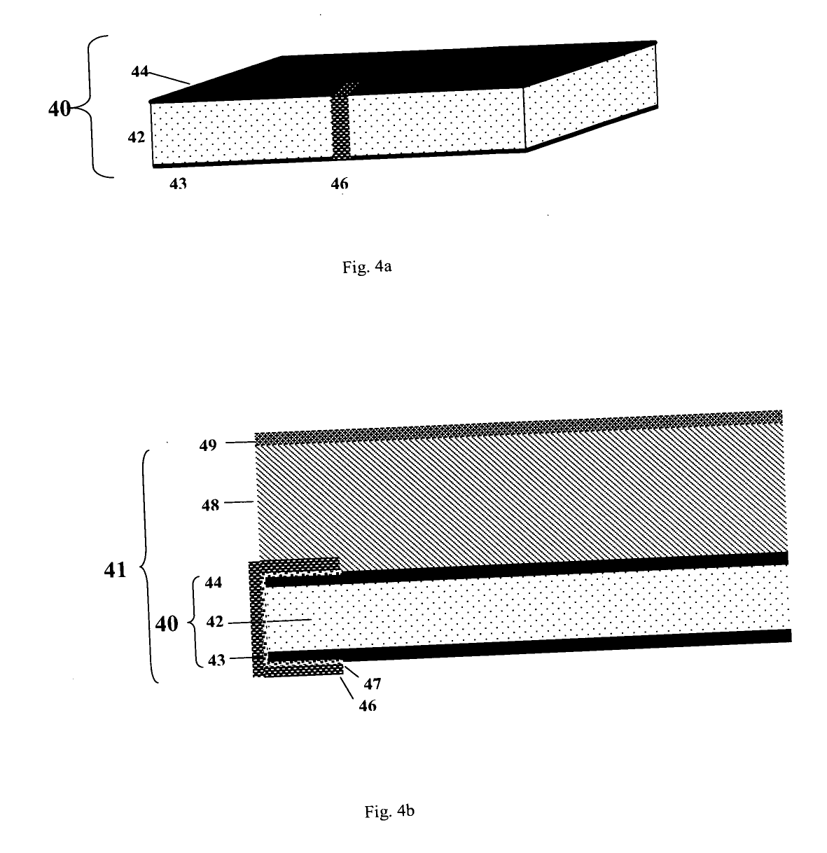

A fourth embodiment of the invention may be found in FIGS. 4 (a) and 4 (b). Shown in FIG. 4 (a) a is intermediate transfer substrate 40 including an insulating plastic film 42 having surface conductive layers 43 and 44 deposited on either side of film 42. A tape 46 having a conductive adhesive 47 is folded over one edge of intermediate transfer substrate 40. This electrical connection using tape 46 may be repeated in multiple locations. Conductive adhesive 47 provides a low resistance electrical path between conductive layers 43 and 44. In addition, tape 46 may also be conductive so as to minimize the loss of electric field in a transfer nip. Shown in FIG. 4 (b) is intermediate transfer member 41, including intermediate transfer substrate 40 with compliant layer 48 coated on top of conductive layer 44. Preferably, a release layer 49 is coated on top of compliant layer 48. The materials for use as intermediate transfer member 40, compliant layer 48, and release layer 49 in this embodiment are the same as those listed for the first embodiment.

An example of a conductive tape 46 having a conductive adhesive 47 is 3M™ 1181 EMI Copper Foil Shielding Tape 1181.

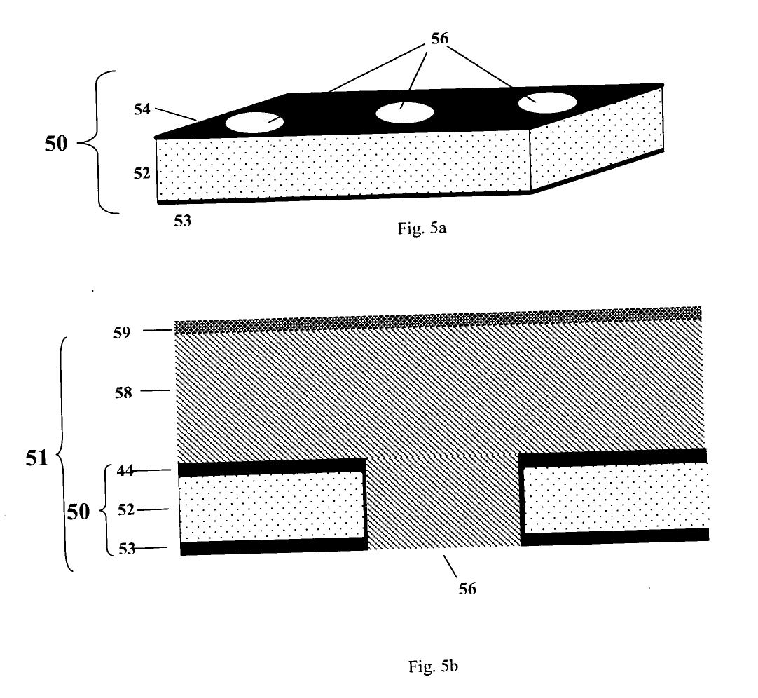

A fifth embodiment of the invention may be found in FIGS. 5 (a) and 5 (b). Shown in FIG. 5 (a) is intermediate transfer substrate 50 including an insulating plastic film 52 having surface conductive layers 53 and 54 deposited on either side of film 52. A pattern of holes or perforations 56 has been made in intermediate transfer substrate 30. Shown in FIG. 5 (b) is intermediate transfer member 51, consisting of intermediate transfer substrate 50 with compliant layer 58 coated on top of conductive layer 54 and filling in perforations 56. Preferably, a release layer 59 is coated on top of compliant layer 58. The materials for use as intermediate transfer member 50, compliant layer 58, and release layer 59 in this embodiment are the same as those listed for the first embodiment.

The pattern of perforations 56 is designed such that the remaining plastic film material has sufficient strength so as to provide the rigidity required to serve as a substrate for an intermediate transfer member. If there are too many perforations then the mechanical integrity and strength of film 52 will be significantly reduced. On the other hand, the pattern must provide a sufficient number of channels to effectively provide electrical communication between conductive layers 53 and 54. If there is a sufficient number of perforations then the electrical current flow between conductive layers 53 and 54 will be too low, resulting in a reduction in the toner transfer capability of intermediate transfer member 50.

### EXAMPLE

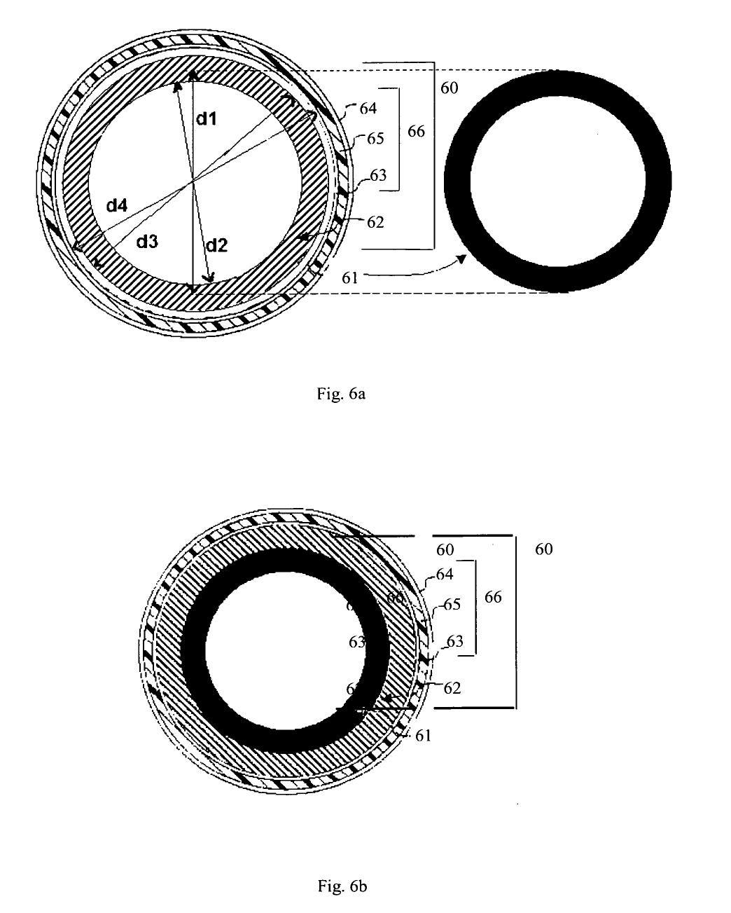

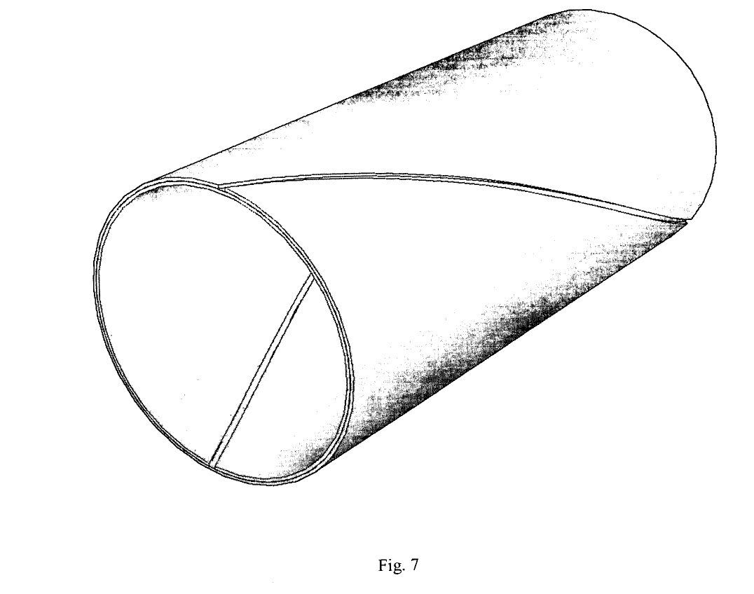

An outer sleeve member (OSM) was made as described below, with reference to OSM 30 in FIG. 6(a). An outer sleeve support layer (OSSL) 63 was assembled from two polyester films of about 0.125 mm thickness with nickel disposed on one surface and an adhesive disposed on the opposite surface of each film. The first layer polyester film was wrapped on an aluminum fabrication mandrel, with an outside diameter of about 172.000 mm (d4), so that the nickel coated surface was in intimate contact with the aluminum mandrel and the ends of the film were brought together to form a butt seam. The seam of the first layer polyester film formed an angle of about 30 degree when measured from a line drawn on the film parallel to the axis of the cylinder. The second layer polyester film was wrapped on the first polyester film so that the adhesives of each film were brought in contact with one another and the ends of the film were brought together to form a second butt seam. The seam of the second layer polyester film was established about 180 deg from the original seam when measured about the axis of the mandrel cylinder and formed an angle of about 30 deg when measured from a line drawn on the film parallel to the axis of the mandrel cylinder. The resulting OSSL is shown in FIG. 7. An outer sleeve compliant layer (OSCL) 65 of polyurethane was cast onto the OSSL, ground to a thickness of about 1.1 mm and ring-coated with about a 6 micrometer thick layer of ceramer to form an outer sleeve release layer (OSRL) 64. An area of roughly 5 cm² was left uncoated on either side of the OSSL, leaving the nickel surface exposed on both sides. A piece of copper tape having a conductive adhesive was used to electrically connect both conductive surfaces of the OSSL, thus effectively removing the insulating polyester film from the effective impedance of the DSITM. The OSM with an inner diameter of 172.000 mm (d4) was then removed from the fabrication mandrel. An inner sleeve member (ISM) was made as described below with reference to ISM 32 in FIG. 6(a). Polyurethane was cast onto a cylindrical nickel core member in a mold, cured and ground so that the final outer diameter was 172.500 mm when mounted on a 154.000 mm device mandrel 31 resident in an electrophotographic machine (a Kodak NexPress 2100). When the ISM was removed from the device mandrel the outside diameter relaxed to a dimension of about 170.3 mm (d3) such that the OSM of about 172.000 mm (d4) inner diameter was slipped over the ISM without interference to form a double-sleeved member (DSM). To mount the DSM device mandrel in the electrophotographic machine a source of a pressurized air delivered by the mandrel was applied to the inner surface of the DSM to elastically expand the ISM member from its initial inner diameter size of about 151.800 mm (d2) to a dimension slightly larger than the mandrel dimension of about 154.000 mm (d1). At the same time the ISM outside dimension of about 170.300 mm (d3) is expanded to about 172.500 mm with the same applied pressurized air creating an interference with the OSM inner diameter of about 172.00 mm (d4). The expansion and subsequent contact between the ISM and OSM that formed the DSM allowed the ISM and OSM to simultaneously move along the surface of a core member until it reached a predetermined position surrounding the core member. Shutting off the source of the pressurized air allowed the DSM to relax and grip the said core member under tension. The roller was subsequently tested as an intermediate transfer member in an electrophotographic machine and was found to make images on the receiver sheets. The DSM was then removed with pressurized air in a similar way to that described for installation with the ISM and OSM simultaneously moving along the surface of a core member until completely removed from the device mandrel. Once removed from the machine the ISM and OSM were separated into two pieces.

The invention has been described in detail with particular reference to certain preferred embodiments thereof, but it will be understood that variations and modifications can be effected within the spirit and scope of the invention.

It is claimed:

1. An intermediate transfer member for use in an electrostatographic machine, comprising:
a insulating support layer having an inner side and outer side;
a conductive outer layer disposed on the outer side of said insulating layer; and
at least one conductive connection between the inner side of the insulating support layer and the conductive outer layer.

2. An intermediate transfer member of claim 1 further comprising: a second conductive layer disposed on the inner side of said insulating support layer.

3. The intermediate transfer member of claim 1 further comprising:
a compliant layer disposed on the conductive layer; and
a release layer disposed on said compliant layer.

4. The intermediate transfer layer member of claim 1 wherein said at least one conductive connection comprises conductive adhesive.

5. The intermediate transfer layer member of claim 1 wherein said at least one conductive connection comprises conductive tape.

6. The intermediate transfer layer member of claim 1 wherein said at least one conductive connection comprises conductive material contained in voids in said insulating support layer.

7. The intermediate transfer member of claim 1 wherein the insulating support layer is selected from the group consisting of polyesters, polyurethanes, polyimides, polyvinyl chlorides, polyolefins, polyamides, polycarbonates, acrylics or fluorinated polymers,

8. The intermediate transfer member of claim 1 wherein the conductive outer layer is selected form the group consisting of aluminum, nickel, indium tin oxide, solution coated polythiophene, tin oxide, carbon black, carbon nanotubes, or polyaniline.

9. The intermediate transfer member of claim 1 wherein the conductive connection comprises solder, paint, epoxy or paste having a conductive material.

10. The intermediate transfer member of claim 9 wherein the conductive material comprises silver, carbon black, carbon fibers or carbon nanotubes.

11. The intermediate transfer member of claim 3 wherein the compliant layer comprises polyurethanes, neoprenes, silicones, fluoropolymers, silicone-fluoropolymer hybrids, nitrites, or silicon-nitriles.

12. The intermediate transfer member of claim 3 wherein the release layer comprises sol-gels, ceramers, polyurethanes or fluoropolymers.

13. The intermediate transfer member of claim 4 wherein the conductive adhesive comprises polyamide, urethane, polyesters, acrylic epoxy, polyvinyl butyral incorporating a conductive component.

14. The intermediate transfer member of claim 13 wherein the conductive component comprises silver, indium tin oxide, cuprous iodide, tin oxide, 7,7′,8,8′-tetracyanoquinonedimethane, quinoline, carbon black, NiO, ionic, metal oxides, graphite, or conductive polymers.
